(19) United States
(12) Patent Application Publication
(10) Pub. No.: US 2002/0047986 A1
(43) Pub. Date: Apr. 25, 2002

(54) Eyeglass assembly and method for converting an existing non-magnetic primary eyeglass frame to a magnetic eyeglass frame and for attaching an auxiliary eyeglass frame to the primary eyeglass frame

(76) Inventor: Arun Jaswant Jagasia, Mumbai (IN)

Correspondence Address: LERNER AND GREENBERG, P.A., POST OFFICE BOX 2480, HOLLYWOOD, FL, 33022-2480, US

(21) Appl. No.: 09/974,926

(22) Filed: Oct. 10, 2001

Related U.S. Application Data
(60) Provisional application No. 60/239,438, filed on Oct. 10, 2000.

(51) Int. Cl. G02C 5/00

(52) U.S. Cl. 351/140

(57) ABSTRACT

An eyeglass assembly and a method for converting a non-magnetic primary eyeglass frame to a magnetic eyeglass frame and for attaching an auxiliary eyeglass frame to the primary frame include the non-magnetic primary frame, a magnetic auxiliary frame, and a removable magnetic connector. The non-magnetic frame utilizes two non-magnetic lens screws to hold a lens pair and two non-magnetic temple screws to pivotably hold temples. The auxiliary frame has at least one magnetic member. The removable magnetic connector replaces at least one of the non-magnetic lens or temple screws. Thus, the non-magnetic frame is converted to a magnetic frame able to hold the magnetic auxiliary frame thereon. The removable magnetic connector can be a screw having a magnetic portion or an assembly including a screw and a magnetic attachment that is held on the primary frame by the screw, which can be one of the existing lens or temple screws.

### CROSS REFERENCE TO RELATED APPLICATION

This application claims the benefit of U.S. Provisional Application No. 60/239,438, filed Oct. 10, 2000.

### BACKGROUND OF THE INVENTION

1. Field of the Invention

The invention lies in the field of eyewear. The invention relates to an apparatus and method of a magnetic clip-on attachment for an eyeglass frame, and, more particularly, to an eyeglass assembly and method for converting an existing non-magnetic eyeglass frame to a magnetic eyeglass frame and for attaching an auxiliary eyeglass frame to the primary eyeglass frame.

Use of magnetic material to engage a primary frame having a first pair of lenses with an auxiliary frame having a second pair of lenses exists in the art. Normally, the first pair of the lenses are eyeglass lenses, and the second pair of the lenses are sunglass lenses or lenses with a material or coating thereon to filter ultraviolet light or other specific wavelengths of light for eye protection. Among other advantages, such a combination can offer a user an option to put on the sunglass lenses or lenses with a material or coating thereon with the primary frame for eye protection, and to remove the auxiliary frame from the primary frame to reduce load at the user's choice.

However, the eyeglass devices using currently available magnetic engagement mechanism require that there be a magnetic engagement mechanism existing between the auxiliary frame and the primary frame. Normally, the auxiliary frame and the primary frame each have at least one magnet embedded therein at a proper position for engaging one another and securing the auxiliary frame and the primary frame together.

On the other hand, most optical frames available on the market today are sold without any pre-existing magnetic parts. Thus, a user purchasing such an optical frame can just use it as a primary frame with a pair of lenses. If the user wants to have a pair of sunglass lenses or lenses with a material or coating thereon to filter ultraviolet light or other specific wavelengths of light, the user may have to purchase a new set of magnetic frames, which not only may be costly but may be a waste.

Therefore, there is a need for a new apparatus and method for converting an existing non-magnetic eyeglass frame to a magnetic eyeglass frame and attaching an auxiliary eyeglass frame to the primary eyeglass frame.

### SUMMARY OF THE INVENTION

It is accordingly an object of the invention to provide an eyeglass assembly and method for converting an existing non-magnetic eyeglass frame to a magnetic eyeglass frame and for attaching an auxiliary eyeglass frame to the primary eyeglass frame that overcomes the hereinafore-mentioned disadvantages of the heretofore-known devices of this general type and that simplifies the conversion as much as possible.

With the foregoing and other objects in view, there is provided, in accordance with the invention, an eyeglass assembly for converting an existing non-magnetic primary eyeglass frame to a magnetic eyeglass frame and for magnetically attaching an auxiliary eyeglass frame to the primary eyeglass frame, the assembly including a non-magnetic primary eyeglass frame, an auxiliary eyeglass frame, and two removable magnetic connectors for converting the non-magnetic primary eyeglass frame into a magnetic eyeglass frame. The non-magnetic primary eyeglass frame has a first pair of lenses and a primary portion holding the first pair of lenses. The primary portion has a rear side, two rims each connected to one respective lens of the first pair of lenses, and two end pieces each extending away from the rear side and each having a rear end and a hinge portion disposed at the rear end. The primary portion also has two non-magnetic lens screws for fastening each of the rims to a respective lens of the first pair of lenses, each of the two non-magnetic lens screws removably connected to a respective rim of the two rims, two temples each having a forward end and a hinge member disposed at the forward end, and two non-magnetic temple screws for securing each of the two temples to a respective one of the two end pieces, each of the two non-magnetic temple screws rotatably connecting one of the two temples to the hinge portion of one of the two end pieces. The auxiliary eyeglass frame has a second pair of lenses and an auxiliary portion holding the second pair of lenses. The auxiliary portion has two ends and two magnetic members each disposed at a respective one of the two ends. The two removable magnetic connectors replace at least one of the two non-magnetic lens or temple screws. Each of the two magnetic connectors is to be magnetically coupled to a respective one of the two magnetic members for removably securing the auxiliary eyeglass frame to the primary eyeglass frame.

In accordance with another feature of the invention, the two magnetic connectors are magnetic screws.

In accordance with a further feature of the invention, the magnetic screws replace the two non-magnetic lens screws or the two non-magnetic temple screws.

In accordance with an added feature of the invention, the auxiliary eyeglass frame has a rear side, two arms are disposed at a respective one of the two ends and extending away from the rear side, and each of the two magnetic members is secured to a respective one of the two arms.

In accordance with an additional feature of the invention, the two removable magnetic connectors each include a magnetic extension having a magnetic and an attachment device, and a screw removably securing the magnetic extension to the primary eyeglass frame by the attachment device. Preferably, the attachment device is a flange defining a hole and the screw secures the magnetic extension to the primary eyeglass frame by passing through the hole.

With the objects of the invention in view, there is also provided an eyeglass assembly for converting an existing non-magnetic primary eyeglass frame to a magnetic eyeglass frame and for magnetically attaching an auxiliary eyeglass frame to the primary eyeglass frame, the assembly including a non-magnetic primary eyeglass frame, an auxiliary eyeglass frame and a removable means for converting the non-magnetic primary eyeglass frame into a magnetic eyeglass frame. The removable converting means replaces at least one of two non-magnetic lens or temple screws of the primary frame. The removable converting means is to be magnetically coupled to the two magnetic members for removably securing the auxiliary eyeglass frame to the primary eyeglass frame.

With the objects of the invention in view, in an eyeglass assembly with a non-magnetic primary eyeglass frame and an auxiliary eyeglass frame, there is also provided an improvement for converting the non-magnetic primary eyeglass frame to a magnetic eyeglass frame and for magnetically attaching the auxiliary eyeglass frame to the primary eyeglass frame. The improvement includes two removable magnetic connectors replacing at least one of the two non-magnetic lens or temple screws of the primary frame and each of the two magnetic connectors is to be magnetically coupled to a respective one of the two magnetic members of the auxiliary eyeglass frame.

With the objects of the invention in view, in an eyeglass assembly with a non-magnetic primary eyeglass frame and an auxiliary eyeglass frame there is also provided a an improvement including removable means for converting the non-magnetic primary eyeglass frame into a magnetic eyeglass frame, the removable converting means replacing at least one of the two non-magnetic lens or temple screws of the primary frame. The removable converting means is to be magnetically coupled to the two magnetic members of the auxiliary eyeglass frame for removably securing the auxiliary eyeglass frame to the primary eyeglass frame.

With the objects of the invention in view, in combination with a non-magnetic primary eyeglass frame and an auxiliary eyeglass frame there is also provided an eyeglass converter for converting the non-magnetic primary eyeglass frame to a magnetic eyeglass frame and for magnetically attaching the auxiliary eyeglass frame to the primary eyeglass frame, the converter including two removable magnetic connectors replacing at least one of the two non-magnetic lens or temple screws of the primary frame, and each of the two removable magnetic connectors is to be magnetically coupled to a respective one of the two magnetic members of the auxiliary eyeglass frame.

With the objects of the invention in view, in combination with a non-magnetic primary eyeglass frame and an auxiliary eyeglass frame, there is also provided an eyeglass converter including removable means for converting the non-magnetic primary eyeglass frame into a magnetic eyeglass frame, the removable converting means replacing at least one of the two non-magnetic lens or temple screws of the primary frame. The removable converting means is to be magnetically coupled to the two magnetic members of the auxiliary eyeglass frame for removably securing the auxiliary eyeglass frame to the primary eyeglass frame.

With the objects of the invention in view, there is also provided an eyeglass conversion kit for converting an existing non-magnetic primary eyeglass frame to a magnetic eyeglass frame, the conversion kit including an auxiliary eyeglass having at least one magnetic member, and at least one magnetic screw replacing at least one non-magnetic screw of the non-magnetic primary eyeglass frame, the at least one magnetic screw to be magnetically coupled to the at least one magnetic member for removably attaching the auxiliary eyeglass to the primary eyeglass frame.

With the objects of the invention in view, there is also provided a converting eyewear assembly including a non-magnetic primary eyeglass frame having at least one non-magnetic screw, an auxiliary eyeglass having at least one magnetic member, and at least one magnetic screw replacing the at least one non-magnetic screw, the at least one magnetic screw to be magnetically coupled to the at least one magnetic member for removably attaching the auxiliary eyeglass to the primary eyeglass frame.

With the objects of the invention in view, there is also provided an eyeglass conversion kit for converting an existing non-magnetic primary eyeglass frame having at least one non-magnetic screw to a magnetic eyeglass frame to be magnetically coupled to an auxiliary eyeglass having at least one magnetic member, the conversion kit including at least one magnetic screw replacing at least one non-magnetic screw of the non-magnetic primary eyeglass frame, the at least one magnetic screw to be magnetically coupled to the at least one magnetic member of the auxiliary eyeglass for removably attaching the auxiliary eyeglass to the primary eyeglass frame.

With the objects of the invention in view, there is also provided a method for converting an existing non-magnetic primary eyeglass frame to a magnetic eyeglass frame and for attaching an auxiliary eyeglass frame to the primary eyeglass frame, including the steps of providing a non-magnetic primary eyeglass frame and an auxiliary eyeglass frame, replacing at least one of the two non-magnetic lens screws and the two non-magnetic temple screws with at least one removable magnetic connector, and detachably attaching the auxiliary eyeglass frame to the primary eyeglass frame by engaging the magnetic members of the auxiliary eyeglass frame with the magnetic connector.

In accordance with yet another mode of the invention, the replacement step is performed by replacing at least one of the two non-magnetic lens or temple screws with removable magnetic connectors.

In accordance with yet a further mode of the invention, the replacement step is performed by replacing two non-magnetic temple or lens screws with magnetic screws.

In accordance with yet an added mode of the invention, each of the magnetic connectors is a screw having a magnetic.

In accordance with yet an additional mode of the invention, each of the forward ends of the two temples has a top side, and including the further steps of removing each of the two non-magnetic temple screws, and replacing each of the two non-magnetic temple screws with a removable magnetic connector screwed into a respective forward end from the top side through the hinge member.

In accordance with again another mode of the invention, each of the forward ends of the two temples has a bottom side, and including the further steps of removing each of the two non-magnetic temple screws, and replacing each of the two non-magnetic temple screws with a removable magnetic connector screwed into a respective forward end from the bottom side through the hinge member.

In accordance with again a further mode of the invention, the replacement step is performed by removing at least one screw of the two non-magnetic lens or temple screws, threading the removed screw through a magnetic extension, and replacing the removed screw back onto the primary eyeglass frame with the attached magnetic extension.

In accordance with again an added mode of the invention, the magnetic extension includes a flange having a hole and a magnetic attached to the flange; and including the further steps of threading the removed screw through the hole, and replacing the removed screw back onto the primary eyeglass frame with the attached magnetic extension to secure the magnetic extension to the primary eyeglass frame.

With the objects of the invention in view, there is also provided a method for converting an existing non-magnetic primary eyeglass frame to a magnetic eyeglass frame and for attaching an auxiliary eyeglass frame to the primary eyeglass frame including the steps of replacing at least one non-magnetic screw of a non-magnetic primary eyeglass frame with at least one removable magnetic connector, and detachably attaching an auxiliary eyeglass frame to the primary eyeglass frame by engaging magnetic members of the auxiliary eyeglass frame with the removable magnetic connector.

Other features that are considered as characteristic for the invention are set forth in the appended claims.

Although the invention is illustrated and described herein as embodied in an eyeglass assembly and method for converting an existing non-magnetic eyeglass frame to a magnetic eyeglass frame and for attaching an auxiliary eyeglass frame to the primary eyeglass frame, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

Additional advantages of the invention will be set forth in part in the description which follows, and in part will be obvious from the description, or may be learned by practice of the invention. The advantages of the invention will be realized and attained by the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a front elevational view of an auxiliary eyeglass frame with lenses;

FIG. 2 is a top elevational view of the auxiliary eyeglass frame of FIG. 1 showing a configuration of the magnetic members;

FIG. 3 is a top elevational view of an alternative embodiment of the magnetic members of the auxiliary eyeglass frame of FIG. 1;

FIG. 4 is a fragmentary, top elevational view of a primary eyeglass frame with lenses;

FIG. 5 is a cross-sectional view of a magnetic connector according to the invention;

FIG. 6 is a fragmentary, top elevational view of the primary eyeglass frame of FIG. 4 and the auxiliary eyeglass frame of FIG. 2 with a first embodiment of the magnetic connector according to the invention;

FIG. 7 is a fragmentary, top elevational view of the primary eyeglass frame of FIG. 4 and the auxiliary eyeglass frame of FIG. 3 with a second embodiment of the magnetic connector according to the invention;

FIG. 8a is a fragmentary, perspective view of a disassembled alternative embodiment of magnetic connector according to the invention with the frames of FIG. 6;

FIG. 8b is a fragmentary, perspective view of the assembled magnetic connector of FIG. 8a;

FIG. 9a is a fragmentary, perspective view of a temple screw removed from a prior art non-magnetic primary eyeglass frame; and

FIG. 9b is a fragmentary, perspective view of an alternative embodiment of the magnetic connector of FIG. 5 replacing the temple screw of FIG. 9a either from above or from below.

### DETAILED DESCRIPTION OF THE PREFERRED EMBODIMENTS

The invention may be understood more readily by reference to the following detailed description of preferred embodiments of the invention.

Before the invention is disclosed and described, it is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

The invention will now be described in detail with reference to the accompanying drawings.

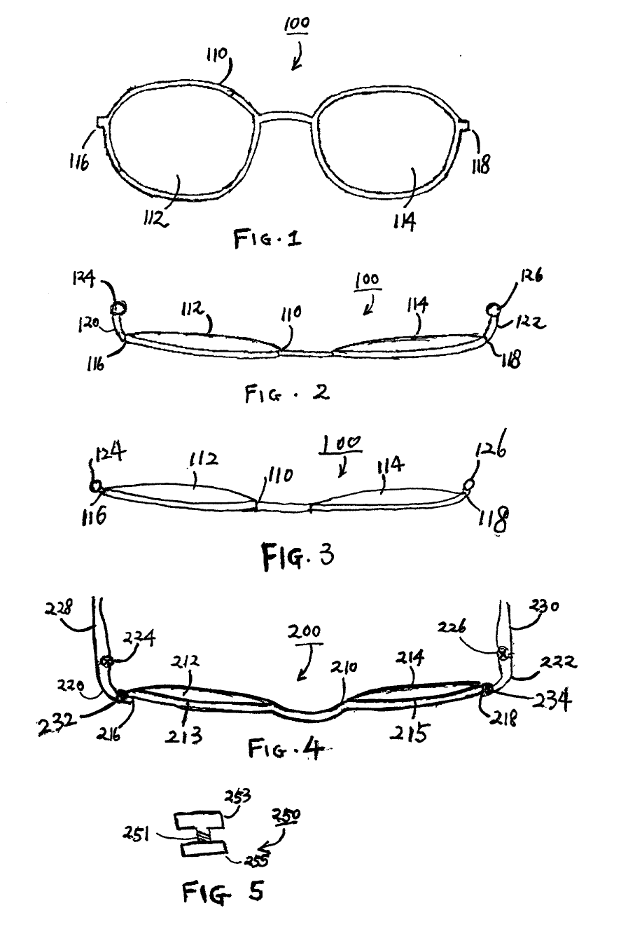

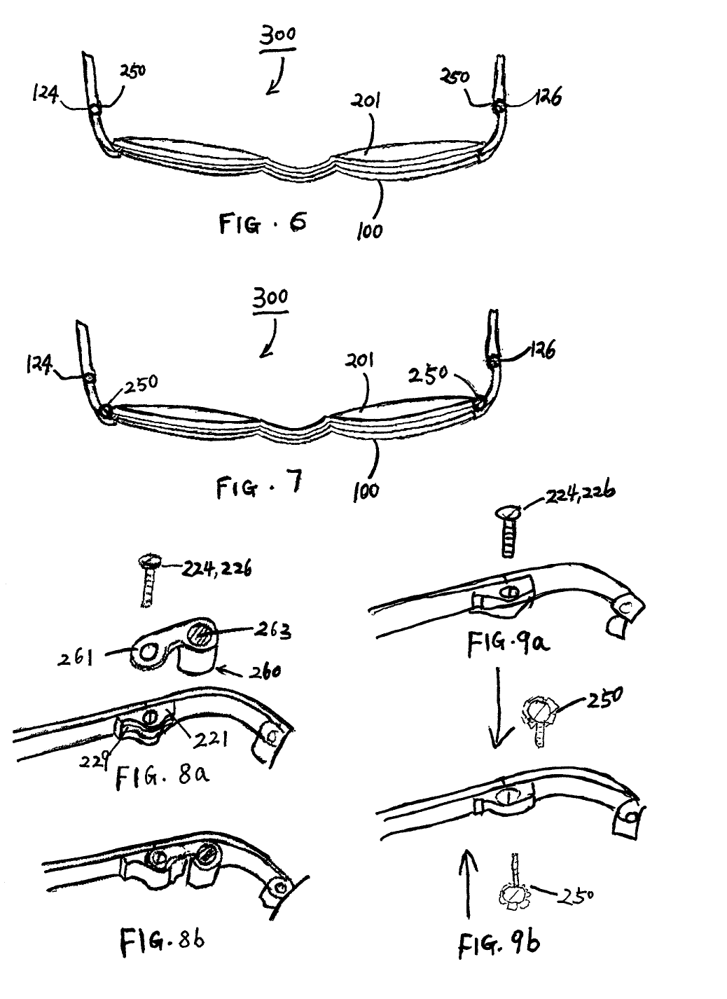

Referring to the drawings and, initially to FIGS. 1 and 2, an auxiliary frame 100 that can be utilized in the invention includes a forward portion 110 for holding a pair of lenses 112, 114 and having two opposite ends 116, 118. A first arm 120 is attached to one end 116 of the forward portion 110 and has a magnetic member 124 secured thereto. A second arm 122 is attached to the other end 118 of the forward portion 110 and having a magnetic member 126 secured thereto. In one embodiment, each magnetic member is substantially circular in cross-section. The magnetic members 124, 126 can alternatively take geometric shapes other than circular such as rectangular, square, diamond, oval, etc. The magnetic members 124, 126 are made from magnetic materials existing in the art. In the embodiment shown in FIG. 3, the magnetic members 124, 126 are secured directly to the opposite ends 116, 118.

Referring now to FIG. 4, a non-magnetic primary eyeglass frame 200 that can be utilized in the invention includes a front portion 210 for holding a pair of lenses 212, 214. The front portion 210 has two opposed ends 216, 218, each with a respective end piece 220, 222. The end pieces 220, 222 are attached to the opposite ends of the front portion through lens screws 232, 234. A first temple 228 is attached to one end piece 220 of the front portion 210 through a temple screw 224. A second temple 230 is attached to the other end piece 222 of the front portion 210 through a temple screw 226 as well. The first and second temples 228, 230 can extend rearward from the front portion 210. The temple screws 224, 226 are non-magnetic.

An example of the magnetic screw 250 according to the invention is shown in the cross-sectional view of FIG. 5. The Magnetic screw 250 is provided for converting the non-magnetic eyeglass frame 200 into a magnetic eyeglass frame. An essential aspect of the invention is that the magnetic connector 250, in particular, the magnetic screw 250 is removable.

In one embodiment, the magnetic screw 250 has a body 251, a top part 253, and a bottom part 255. The top and bottom parts 253, 255 can be embodied as a nut. The magnetic screw 250 can be wholly made from magnetic materials existing in the art. Alternatively, the magnetic screw 250 can be partially magnetic. For example, either or both the top and bottom parts 253, 255 can be magnetic while the body 251 can be non-magnetic. The magnetic screw 250 can take various geometric shapes. Additionally, a magnetic plug can be utilized to practice the invention as well.

FIG. 8a illustrates an alternative embodiment of the magnetic connector 250 shown in FIG. 5. Magnetic connector 260 includes a removable magnetic insert device 263 and an attachment 261. Preferably, the attachment 261 can be a housing for a magnetic insert, with the housing having a flange with a hole. The magnetic insert can be secured on the top or bottom of the magnetic insert device 263. Thus, depending on the length of the screw already existing in the non-magnetic primary eyeglass frame 200, the magnetic connector 260 can be retrofitted onto the existing in the non-magnetic primary eyeglass frame 200 using the original screw 224, 226. As before, the essential feature of the inventive magnetic connector 260 is that it is removable.

In operation, any number of temple screws 224, 226 and lens screws 232, 234 of the non-magnetic eyeglass frame 200 are replaced with a respective magnetic connector 250, 260. Particularly, each of the two temple screws 224, 226 or each of the two lens screws of the non-magnetic eyeglass frame 200 are replaced with a magnetic connector 250, 260 to form a magnetic primary eyeglass frame 201, as shown in FIGS. 6 and 7.

Subsequently, as shown in FIGS. 6 and 7, an auxiliary frame 100 can be detachably attached to the magnetic primary eyeglass frame 201 to form a magnetic eyeglass assembly 300, wherein at least one of the magnetic members 124, 126 engages at l east one magnetic connector 250, 260 of the primary frame 201 such that the auxiliary frame 100 is held adjacent the primary frame 201 and each lens 112, 114 of the auxiliary frame 100 is in alignment with a respective lens 212, 214 of the primary frame 200. These two pairs of lenses can have same or different optical characteristics such as focal point, color, refracting power, reflecting power, transparency, etc. In the preferred embodiment, one pair of the lenses are eyeglasses lenses, and the other pair of the lenses are sunglass lenses or lenses with a material or coating thereon to filter ultraviolet light or other specific wavelengths of light.

The ease at which the non-magnetic primary eyeglass frame 200 can be converted to the magnetic primary eyeglass frame 201 allows the further possibility of converting the magnetic primary eyeglass frame 201 back to a non-magnetic primary eyeglass frame 200 at any time.

As shown in FIGS. 9a and 9b, for example, a temple screw 224, 226 can be removed from the eyeglass hinge, made of the frame hinge part 221 and the temple hinge part 229. Then, a magnetic screw 250 is substituted in place of the temple screw 224, 226 by insertion into the eyeglass hinge either from is above the hinge or from below the hinge.

Other embodiments of the invention will be apparent to those skilled in the art from consideration of the specification and practice of the invention disclosed herein. It is intended that the specification and examples be considered as exemplary only.

I claim:

1. An eyeglass assembly for converting an existing non-magnetic primary eyeglass frame to a magnetic eyeglass frame and for magnetically attaching an auxiliary eyeglass frame to the primary eyeglass frame, the assembly comprising:
a non-magnetic primary eyeglass frame having:
a first pair of lenses;
a primary portion holding said first pair of lenses, said primary portion having:
a rear side;
two rims each connected to one respective lens of said first pair of lenses; and
two end pieces each extending away from said rear side and each having a rear end and a hinge portion disposed at said rear end;
two non-magnetic lens screws for fastening each of said rims to a respective lens of said first pair of lenses, each of said two non-magnetic lens screws removably connected to a respective rim of said two rims;
two temples each having:
a forward end; and
a hinge member disposed at said forward end; and
two non-magnetic temple screws for securing each of said two temples to a respective one of said two end pieces, each of said two non-magnetic temple screws rotatably connecting one of said two temples to said hinge portion of one of said two end pieces;
an auxiliary eyeglass frame having:
a second pair of lenses; and
an auxiliary portion holding said second pair of lenses, said auxiliary portion having:
two ends; and
two magnetic members each disposed at a respective one of said two ends; and
two removable magnetic connectors for converting said non-magnetic primary eyeglass frame into a magnetic eyeglass frame, said two magnetic connectors replacing at least one of:
said two non-magnetic lens screws; and
said two non-magnetic temple screws;
each of said two magnetic connectors to be magnetically coupled to a respective one of said two magnetic members for removably securing said auxiliary eyeglass frame to said primary eyeglass frame.

2. The eyeglass assembly according to claim 1, wherein said two magnetic connectors are magnetic screws.

3. The eyeglass assembly according to claim 2, wherein said magnetic screws replace said two non-magnetic lens screws.

4. The eyeglass assembly according to claim 2, wherein said magnetic screws replace said two non-magnetic temple screws.

5. The eyeglass assembly according to claim 1, wherein:
said auxiliary eyeglass frame has:
a rear side; and
two arms disposed at a respective one of said two ends
and extending away from said rear side; and
each of said two magnetic members is secured to a respective one of said two arms.

6. The eyeglass assembly according to claim 1, wherein said two magnetic connectors each include:
a magnetic extension having:
a magnetic; and
an attachment device; and
a screw removably securing said magnetic extension to said primary eyeglass frame by said attachment device.

7. The eyeglass assembly according to claim 6, wherein:
said attachment device is a flange defining a hole; and
said screw secures said magnetic extension to said primary eyeglass frame by passing through said hole.

8. An eyeglass assembly for converting an existing non-magnetic primary eyeglass frame to a magnetic eyeglass frame and for magnetically attaching an auxiliary eyeglass frame to the primary eyeglass frame, the assembly comprising:
a non-magnetic primary eyeglass frame having:
a first pair of lenses;
a primary portion holding said first pair of lenses, said primary portion having:
a rear side;
two rims each connected to one respective lens of said first pair of lenses; and
two end pieces each extending away from said rear side and each having a rear end and a hinge portion disposed at said rear end;
two non-magnetic lens screws for fastening each of said rims to a respective lens of said first pair of lenses, each of said two non-magnetic lens screws removably connected to one of said two rims;
two temples each having:
a forward end; and
a hinge member disposed at said forward end; and
two non-magnetic temple screws for securing each of said two temples to a respective one of said two end pieces, each of said two non-magnetic temple screws rotatably connecting one of said two temples to said hinge portion of one of said two end pieces;
an auxiliary eyeglass frame having:
a second pair of lenses; and
an auxiliary portion holding said second pair of lenses, said auxiliary portion having:
two ends; and
two magnetic members each disposed at a respective one of said two ends; and
removable means for converting said non-magnetic primary eyeglass frame into a magnetic eyeglass frame, said removable converting means replacing at least one of:
said two non-magnetic lens screws; and
said two non-magnetic temple screws;
said removable converting means to be magnetically coupled to said two magnetic members for removably securing said auxiliary eyeglass frame to said primary eyeglass frame.

9. In an eyeglass assembly with:
a non-magnetic primary eyeglass frame having:
a first pair of lenses;
a primary portion holding the first pair of lenses, the primary portion having:
a rear side;
two rims each connected to one respective lens of the first pair of lenses; and
two end pieces each extending away from the rear side and each having a rear end and a hinge portion disposed at the rear end;
two non-magnetic lens screws for fastening each of the rims to a respective lens of the first pair of lenses, each of the two non-magnetic lens screws removably connected to one of the two rims;
two temples each having:
a forward end; and
a hinge member disposed at the forward end; and
two non-magnetic temple screws for securing each of the two temples to a respective one of the two end pieces, each of the two non-magnetic temple screws rotatably connecting one of the two temples to the hinge portion of one of the two end pieces; and
an auxiliary eyeglass frame having:
a second pair of lenses; and
an auxiliary portion holding the second pair of lenses, the auxiliary portion having:
two ends; and
two magnetic members each disposed at a respective one of the two ends,
an improvement for converting the non-magnetic primary eyeglass frame to a magnetic eyeglass frame and for magnetically attaching the auxiliary eyeglass frame to the primary eyeglass frame, the improvement comprising:
two removable magnetic connectors replacing at least one of:
the two non-magnetic lens screws; and
the two non-magnetic temple screws;
each of said two magnetic connectors to be magnetically coupled to a respective one of the two magnetic members of the auxiliary eyeglass frame.

10. The eyeglass assembly according to claim 9, wherein said two magnetic connectors are magnetic screws.

11. The eyeglass assembly according to claim 10, wherein said magnetic screws replace said two non-magnetic lens screws.

12. The eyeglass assembly according to claim 10, wherein said magnetic screws replace said two non-magnetic temple screws.

13. The eyeglass assembly according to claim 9, wherein said two magnetic connectors each include:
a magnetic extension having:
a magnetic; and
an attachment device; and
a screw removably securing said magnetic extension to the primary eyeglass frame by said attachment device.

14. The eyeglass assembly according to claim 13, wherein:
said attachment device is a flange defining a hole; and
said screw secures said magnetic extension to the primary eyeglass frame by passing through said hole.

15. In an eyeglass assembly with:
a non-magnetic primary eyeglass frame having:
a first pair of lenses;
a primary portion holding the first pair of lenses, the primary portion having:
a rear side;
two rims each connected to one respective lens of the first pair of lenses; and
two end pieces each extending away from the rear side and each having a rear end and a hinge portion disposed at the rear end;
two non-magnetic lens screws for fastening each of the rims to a respective lens of the first pair of lenses, each of the two non-magnetic lens screws removably connected to one of the two rims;
two temples each having:
a forward end; and
a hinge member disposed at the forward end; and
two non-magnetic temple screws for securing each of the two temples to a respective one of the two end pieces, each of the two non-magnetic temple screws rotatably connecting one of the two temples to the hinge portion of one of the two end pieces; and
an auxiliary eyeglass frame having:
a second pair of lenses; and
an auxiliary portion holding the second pair of lenses, the auxiliary portion having:
two ends; and
two magnetic members each disposed at a respective one of the two ends,
an improvement, comprising:
removable means for converting the non-magnetic primary eyeglass frame into a magnetic eyeglass frame, said removable converting means replacing at least one of:
the two non-magnetic lens screws; and
the two non-magnetic temple screws;
said removable converting means to be magnetically coupled to the two magnetic members of the auxiliary eyeglass frame for removably securing the auxiliary eyeglass frame to the primary eyeglass frame.

16. In combination with:
a non-magnetic primary eyeglass frame having:
a first pair of lenses;
a primary portion holding the first pair of lenses, the primary portion having:
a rear side;
two rims each connected to one respective lens of the first pair of lenses; and
two end pieces each extending away from the rear side and each having a rear end and a hinge portion disposed at the rear end;
two non-magnetic lens screws for fastening each of the rims to a respective lens of the first pair of lenses, each of the two non-magnetic lens screws removably connected to one of the two rims;
two temples each having:
a forward end; and
a hinge member disposed at the forward end; and
two non-magnetic temple screws for securing each of the two temples to a respective one of the two end pieces, each of the two non-magnetic temple screws rotatably connecting one of the two temples to the hinge portion of one of the two end pieces; and
an auxiliary eyeglass frame having:
a second pair of lenses; and
an auxiliary portion holding the second pair of lenses, the auxiliary portion having:
two ends; and
two magnetic members each disposed at a respective one of the two ends;
an eyeglass converter for converting the non-magnetic primary eyeglass frame to a magnetic eyeglass frame and for magnetically attaching the auxiliary eyeglass frame to the primary eyeglass frame, the converter comprising:
two removable magnetic connectors replacing at least one of:
the two non-magnetic lens screws; and
the two non-magnetic temple screws;
each of said two magnetic connectors to be magnetically coupled to a respective one of the two magnetic members of the auxiliary eyeglass frame.

17. The eyeglass assembly according to claim 16, wherein said two magnetic connectors are magnetic screws.

18. The eyeglass assembly according to claim 17, wherein said magnetic screws replace said two non-magnetic lens screws.

19. The eyeglass assembly according to claim 17, wherein said magnetic screws replace said two non-magnetic temple screws.

20. The eyeglass assembly according to claim 16, wherein said two magnetic connectors each include:
a magnetic extension having:
a magnetic; and
an attachment device; and
a screw removably securing said magnetic extension to the primary eyeglass frame by said attachment device.

21. The eyeglass assembly according to claim 20, wherein:
said attachment device is a flange defining a hole; and
said screw secures said magnetic extension to the primary eyeglass frame by passing through said hole.

22. In combination with:
a non-magnetic primary eyeglass frame having:
a first pair of lenses;
a primary portion holding the first pair of lenses, the primary portion having:
a rear side;
two rims each connected to one respective lens of the first pair of lenses; and
two end pieces each extending away from the rear side and each having a rear end and a hinge portion disposed at the rear end;
two non-magnetic lens screws for fastening each of the rims to a respective lens of the first pair of lenses, each of the two non-magnetic lens screws removably connected to one of the two rims;
two temples each having:
a forward end; and
a hinge member disposed at the forward end; and
two non-magnetic temple screws for securing each of the two temples to a respective one of the two end pieces, each of the two non-magnetic temple screws rotatably connecting one of
the two temples to the hinge portion of one of the two end pieces; and
an auxiliary eyeglass frame having:
a second pair of lenses; and
an auxiliary portion holding the second pair of lenses, the auxiliary portion having:
two ends; and
two magnetic members each disposed at a respective one of the two ends;
an eyeglass converter, comprising:
removable means for converting the non-magnetic primary eyeglass frame into a magnetic eyeglass frame, said removable converting means replacing at least one of:
the two non-magnetic lens screws; and
the two non-magnetic temple screws;
said removable converting means to be magnetically coupled to the two magnetic members of the auxiliary eyeglass frame for removably securing the auxiliary eyeglass frame to the primary eyeglass frame.

23. A method for converting an existing non-magnetic primary eyeglass frame to a magnetic eyeglass frame and for attaching an auxiliary eyeglass frame to the primary eyeglass frame, which comprises:
providing a non-magnetic primary eyeglass frame having:
a first pair of lenses;
a primary portion holding the first pair of lenses, the primary portion having:
a rear side;
two rims each connected to one respective lens of the first pair of lenses; and
two end pieces each extending away from the rear side and each having a rear end and a hinge portion disposed at the rear end;
two non-magnetic lens screws for fastening each of the rims to a respective lens of the first pair of lenses, each of the two non-magnetic lens screws removably connected to one of the two rims;
two temples each having:
a forward end; and
a hinge member disposed at the forward end; and
two non-magnetic temple screws for securing each of the two temples to a respective one of the two end pieces, each of the two non-magnetic temple screws rotatably connecting one of the two temples to the hinge portion of one of the two end pieces; and
providing an auxiliary eyeglass frame having:
a second pair of lenses; and
an auxiliary portion holding the second pair of lenses, the auxiliary portion having:
two ends; and
two magnetic members each disposed at a respective one of the two ends;
replacing at least one of the two non-magnetic lens screws and the two non-magnetic temple screws with at least one removable magnetic connector; and
detachably attaching the auxiliary eyeglass frame to the primary eyeglass frame by engaging the magnetic members of the auxiliary eyeglass frame with the magnetic connector.

24. The method according to claim 23, which further comprises performing the replacement step by replacing at least one of the two non-magnetic lens screws with removable magnetic connectors.

25. The method according to claim 23, which further comprises performing the replacement step by replacing the two non-magnetic temple screws with removable magnetic connectors.

26. The method according to claim 23, wherein each of the magnetic connectors is a screw having a magnetic.

27. The method according to claim 23, wherein each of the forward ends of the two temples has a top side, and which further comprises:
removing each of the two non-magnetic temple screws; and
replacing each of the two non-magnetic temple screws with a removable magnetic connector screwed into a respective forward end from the top side through the hinge member.

28. The method according to claim 23, wherein each of the forward ends of the two temples has a bottom side, and which further comprises:
removing each of the two non-magnetic temple screws; and replacing each of the two non-magnetic temple screws with a removable magnetic connector screwed into a respective forward end from the bottom side through the hinge member.

29. The method according to claim 23, which further comprises performing the replacement step by replacing the two non-magnetic temple screws with magnetic screws.

30. The method according to claim 23, which further comprises performing the replacement step by replacing the two non-magnetic lens screws with magnetic screws.

31. The method according to claim 23, which further comprises performing the replacement step by:
removing at least one screw of:
the two non-magnetic lens screws; and
the two non-magnetic temple screws;
threading the removed screw through a magnetic extension; and
replacing the removed screw back onto the primary eyeglass frame with the attached magnetic extension.

32. The method according to claim 31, wherein said magnetic extension includes a flange having a hole and a magnetic attached to said flange; and which further comprises:
threading the removed screw through the hole; and
replacing the removed screw back onto the primary eyeglass frame with the attached magnetic extension to secure the magnetic extension to the primary eyeglass frame.

33. A method for converting an existing non-magnetic primary eyeglass frame to a magnetic eyeglass frame and for attaching an auxiliary eyeglass frame to the primary eyeglass frame, comprising:
replacing at least one non-magnetic screw (224, 226; 232, 234) of a non-magnetic primary eyeglass frame with at least one removable magnetic connector; and
detachably attaching an auxiliary eyeglass frame to the primary eyeglass frame by engaging magnetic members of the auxiliary eyeglass frame with the magnetic connector.

34. An eyeglass conversion kit for converting an existing non-magnetic primary eyeglass frame to a magnetic eyeglass frame, the conversion kit comprising:
an auxiliary eyeglass having at least one magnetic member; and
at least one magnetic screw replacing at least one non-magnetic screw of the non-magnetic primary eyeglass frame, said at least one magnetic screw to be magnetically coupled to said at least one magnetic member for removably attaching said auxiliary eyeglass to the primary eyeglass frame.

35. A converting eyewear assembly, comprising:
a non-magnetic primary eyeglass frame having at least one non-magnetic screw;
an auxiliary eyeglass having at least one magnetic member; and
at least one magnetic screw replacing said at least one non-magnetic screw, said at least one magnetic screw to be magnetically coupled to said at least one magnetic member for removably attaching said auxiliary eyeglass to said primary eyeglass frame.

36. An eyeglass conversion kit for converting an existing non-magnetic primary eyeglass frame having at least one non-magnetic screw to a magnetic eyeglass frame to be magnetically coupled to an auxiliary eyeglass having at least one magnetic member, the conversion kit comprising:
at least one magnetic screw replacing at least one non-magnetic screw of the non-magnetic primary eyeglass frame, said at least one magnetic screw to be magnetically coupled to the at least one magnetic member of the auxiliary eyeglass for removably attaching the auxiliary eyeglass to the primary eyeglass frame.
